(19) United States
(12) Patent Application Publication
(10) Pub. No.: US 2012/0112905 A1
(43) Pub. Date: May 10, 2012

(54) RADIO FREQUENCY IDENTIFICATION SAFETY SYSTEM

(76) Inventors: Wendy Wecker, Sedley (CA); Johannes Wecker, Sedley (CA); Travis Wiens, Milestone (CA); Corrine Wiens, Milestone (CA); Kristine Vallance, Regina (CA); Geoffrey Vallance, Regina (CA)

(21) Appl. No.: 13/282,198

(22) Filed: Oct. 26, 2011

(30) Foreign Application Priority Data
Nov. 5, 2010 (CA) 2720194

(51) Int. Cl. G08B 1/08

(52) U.S. Cl. 340/539.13

(57) ABSTRACT

A safety system indicating encroachment near dangerous equipment which is activated upon activation of the equipment is provided. The safety system has a transponder having unique identification information embedded in a microchip and an internal power supply. A corresponding reader is coupled to a power supply of the equipment, and has a transceiver and a scanning antenna which outputs a first radio-frequency signal to a pre-programmed radius. When the power supply of the equipment is flowing, the reader is put into an active state capable of receiving information from the transponder. When the transponder encroaches on the pre-programmed radius, the signal of the reader identifies the transponder's identification information, the transponder transmits data to the transceiver using the internal power supply, and the transceiver sends a second radio wave signal to a base unit causing a programmable logic controller to trigger a remote alarm.

This invention is in the field of safety systems, and more particularly to such systems that provide signals of potentially dangerous equipment.

### PRIORITY OF INVENTION

This application claims priority under 35 U.S.C. 119(b) from Canadian Patent Application Number 2,720,194 filed Nov. 5, 2010, the contents of which are incorporated by reference herein in their entirety.

### BACKGROUND

It is natural for parents to have an instinctive concern for the safety of their children, and for caregivers to worry about the safety of vulnerable persons under their care.

This concern is highlighted in a farming setting where there can be many dangerous vehicles and equipment scattered about the farm property. It is therefore necessary for parents and concerned parties to be know whether vulnerable people are near dangerous or hazardous locations and equipment, such as augers, tillers, and tractors. However, this can be problematic when parents or caregivers are not able to provide constant, undivided attention to the people under their care while performing other tasks.

One way this problem has been addressed is by using a global positioning system (GPS) to ascertain the location of people at any given moment. A GPS system uses GPS satellite arrays to determine the exact location of a person carrying a GPS tracking device. That information is then transmitted to a provider website. The tracking device can be incorporated into simple devices such as cellular phones, bracelets, backpacks, and other accessories to be carried by the child or other vulnerable person. The information on the whereabouts of that child or person carrying the tracking device is then made readily available by logging into a provider website on the Internet.

Another way of tracking the whereabouts of people is through the use of Radio-Frequency Identification (RFID) devices. RFID systems transmit the identity of a person wirelessly through radio waves. Essentially, a tag or chip is carried by a user and is read by an RFID reader. A real-time locating system can use active RFID beacons to locate the person carrying the tag. The information about the tag is then sent to a host computer for processing. The data transmitted by the tag can in this way provide identification and location information about the tag. RFID devices can thus be used for tracking children and other vulnerable persons by having the child or other user carry the RFID tag. The parent or caregiver can then obtain the location specifics of the user carrying the tag by logging into the system which receives and processes the location information of the tag.

However, the use of typical GPS and RFID systems to track vulnerable people has many limitations. For example, a caregiver must constantly check in with the provider website or other system which receives the location information of the user in order to determine the location of the user. The caregiver must subsequently determine if the user is in a dangerous location. This is not always possible because it is not always clear which locations are dangerous and which are not. For example, an auger which is not in operation is harmless, while a running auger can be extremely dangerous to any people that go near it, particularly young children and other people requiring special care. The typical GPS and RFID systems are thus able to provide the location of a person carrying a tracking device, but are unable to ascertain whether the location of the person actually poses a risk of harm and can in this way be a source of false positive concern. Furthermore, the caregiver must be particularly diligent in checking in with the system receiving the location information of the person carrying the tracking device. Even if they are diligent in frequently checking on the location of the tracking device, there is no guarantee that they will catch the vulnerable person in a hazardous location before an injury occurs to the person carrying the tracking device, as many minutes, or even hours, may have passed since the vulnerable person entered upon dangerous grounds.

### SUMMARY OF THE INVENTION

The present invention provides a safety system, part of which is carried by a user, that signals encroachment onto set dangerous boundaries. The dangerous boundary can be set around potentially harmful stationary or moving objects, with the ability to differentiate between objects which are in operation and are likely to cause harm, and objects which are not in operation and therefore less likely to pose a risk of harm. The signal of encroachment onto the boundary can be sent to third parties through external devices to send an immediate warning of the user's hazardous position and to give the third party sufficient time to rectify the situation. The signal can also be sent to other external devices that can immediately and automatically aid in the relief of the hazardous situation upon encroachment onto the set dangerous boundaries.

In a broad aspect of the present invention, there is provided a safety system comprising a transponder comprising an internal power supply and a microchip having embedded therein electronically programmed unique identification information. A reader is coupled to a power supply of a piece of equipment, the reader comprising a transceiver and a scanning antenna which outputs a first radio-frequency signal to a pre-programmed radius. A base unit comprises a programmable logic controller. A remote alarm is linked to the programmable logic controller. The reader is put into an active state capable of receiving information from the transponder only when the power supply of equipment is flowing. When the transponder encroaches on the pre-programmed radius, the radio-frequency signal of the active reader identifies the transponder's unique identification information, the transponder transmits data through radio waves to the transceiver using the internal power supply, and the transceiver sends a second radio wave signal to the base unit causing the programmable logic controller to trigger the remote alarm.

### DESCRIPTION OF THE DRAWINGS

While the invention is claimed in the concluding portions hereof, exemplary embodiments are provided in the accompanying detailed description which may be best understood in conjunction with the accompanying diagrams where like parts in each of the several diagrams are labeled with like numbers, and where:

FIG. 1 is a schematic block diagram depicting a safety system in an embodiment of the present invention; and

FIG. 2 is a flow chart depicting the use of the safety system depicted in FIG. 1.

### DETAILED DESCRIPTION OF THE ILLUSTRATED EMBODIMENTS

Radio-frequency identification (RFID) allows the identification of an object through radio frequency transmission. Communication takes place between a reader and a transponder through radio waves. The read time in RFID systems is typically less than 100 milliseconds, providing almost instantaneous information transmission, which is of particular value in the present invention wherein an alarm system is involved. Furthermore, through the use of RFID, direct contact or line-of-sight scanning is not required between the transponder and the reader. In the RFID safety system described herein, the radio-frequency identification type used is active RFID, meaning that the transponder has its own internal power supply, allowing for lengthier transmission distances.

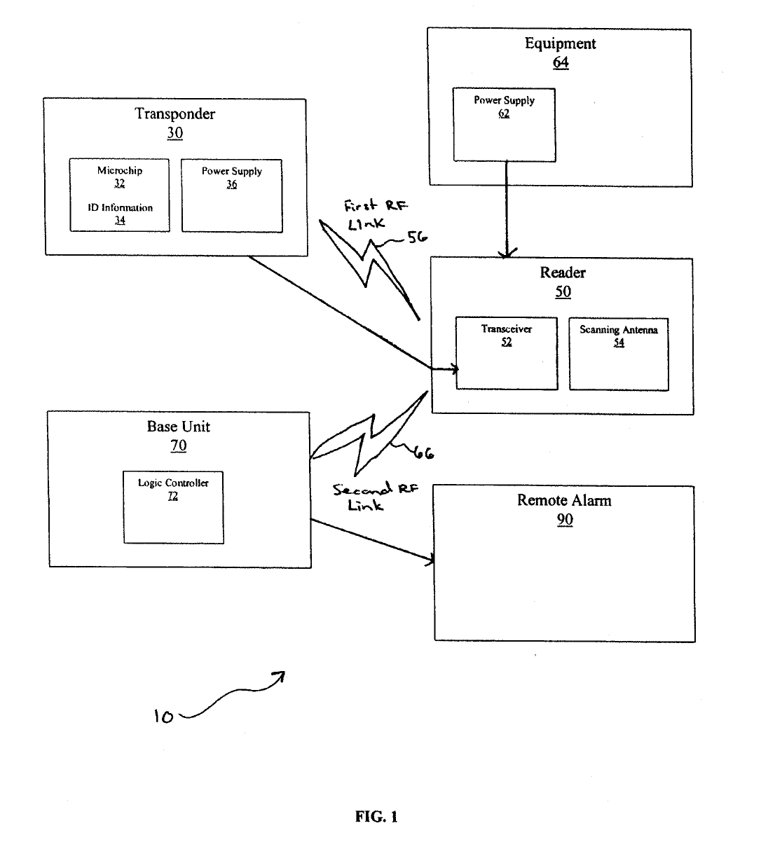

FIG. 1 illustrates a schematic RFID safety system 10 in accordance with an embodiment of the present invention. The safety system 10 has a transponder 30, a reader 50, a base unit 70, and a remote alarm 90.

The transponder 30 has a microchip 32 having embedded therein electronically programmed unique identification information 34. The transponder 30 also has an internal power supply 36. The internal power supply 36 could be any type of power supply including a battery. In an embodiment, the transponder 30 is enclosed within a casing (not shown). The casing could be sealed and the power supply 36 could include at least one non-rechargeable battery. On the other hand, the casing could be accessible with the power supply 36 being a rechargeable battery. The battery could be rechargeable through any conventional means, including charging over a USB cable, through an electrical outlet, or plugging into the cigarette lighter of a vehicle, for example.

The transponder 30 can be carried by a user (not shown). In an embodiment, the transponder 30 has a means of attachment to the user. For example, the transponder 30 can be embedded into personal items such as a user's clothing or shoes. The transponder 30 could alternatively be embedded into an accessory such as a clip that can be attached to a user's belt, backpack, shoelace, or the like. The transponder 30 could be embedded into jewelry, and in an exemplary embodiment is embedded into a bracelet that could be worn around a user's wrist or ankle. The transponder could also be integrated into pieces of jewelry such as necklaces or rings, or into other accessories such as belts and clips. The attachment means could also include a child-safety lock which would prevent the user from removing the transponder 30. The child-safety lock could be any type of child-safety device or lock which is known in the art. In an embodiment, the transponder is attached to an object or an accessory which is easily carried by a user. For example, the transponder 30 could be embedded into a portable electronic device such as a cellular phone or a portable music player. It is also contemplated within the scope of the invention that the system 10 could be used for pets and the transponder 30 could, for example, be embedded into a pet's tag or collar.

The reader 50 has a transceiver 52 and a scanning antenna 54 that outputs a first radio-frequency signal to a pre-programmed radius through a first radio-frequency link 56 (first RF link). The reader 50 is coupled to a power supply 62 of a piece of equipment 64 such that the reader 50 is put into an active state capable of receiving information 34 from the transponder 30 only when the power supply 62 of equipment 64 is flowing. The equipment 64 could be any potentially dangerous machinery or device which, when in operation, could cause harm, including any type of farm machinery. For example, the equipment 64 could be an auger, a tiller device, a tractor, or any powered vehicle. The reader 50 can be permanently affixed to a surface of the equipment 64, and in one embodiment of the present invention, can be built into the equipment 64 itself. In one embodiment, the reader 50 is tied into the ignition of a powered vehicle, such that the reader 50 is only active to send the first RF link 56 when the vehicle is started through the ignition.

The base unit 70 has a programmable logic controller 72. The base unit 70 could be positioned in close proximity to the equipment 64, or further away. The allowable distance of the base unit 70 from the equipment 64 will be dictated by the strength of the radio waves output by the reader 50.

The remote alarm 90 could be placed in any convenient location where a parent or caregiver will take notice of it. For example, the remote alarm could be placed in a house where the parent or caregiver is residing. Furthermore, the remote alarm 90 could be any type of alarm including a flashing light, a loud noise maker, or the combination of the two. It will be evident to one skilled in the art that the remote alarm 90 could take many forms of external devices, including a cell phone wherein the cell phone will ring or give some other notification when triggered.

When the transponder 30 encroaches on the pre-programmed radius of the first RF link 56, the radio-frequency signal of the active reader 50 identifies the transponder's 30 unique identification information 34. The transponder 30 then transmits data through radio waves to the transceiver 52 using the internal power supply 36. It is contemplated within the scope of the invention that the type of information transmitted from the transponder 30 to the transceiver 52 could comprise identification information, information to trigger an alarm, as well as other information such as position. For example, a real-time locating system can be triggered by the reader to use active RFID beacons, which are known in the art, to locate the transponder 30. This location information can be sent the transponder 30 to be transmitted to the transceiver 52, or could be sent directly to the transceiver 52 by the RFID beacons.

The transceiver 52 which receives the information from the transponder 30 sends a second radio wave signal 66 (second RF link) to the base unit 70. The programmable logic controller 72 in the base unit 70 interprets the second RF link 66 to cause the base unit 70 to trigger the remote alarm 90. In an embodiment, location information of the transponder 30 will accompany the remote alarm 90. For example, the remote alarm 90 could be an external device such as a cell phone, which will provide a notification such as a beeping noise when triggered. The base unit 70, at the same time as triggering the remote alarm 90, could also send the location information of the transponder 30 to the cell phone, which could be read off of the cell phone screen. In another embodiment, the location information of the transponder 30 will be sent to a service website to be accessed over the Internet.

The remote alarm 90 would alert a parent or caregiver that the transponder 30 has entered a dangerous boundary, and thus, the user or carrier of the transponder 30 has likely encroached on the dangerous boundary. The parent or caregiver would then presumably take measures to keep the user or carrier of the transponder 30 away from the dangerous equipment 64.

It is contemplated within the scope of the invention that, along with triggering a remote alarm 90, the base unit 70 could trigger a proximate alarm which is near, on, or integral to the equipment 64. Alternatively, the transceiver 52 of the reader 50 could trigger the proximate alarm upon receiving the information from the transponder 30. The proximate alarm could notify the carrier of the transponder 30 that they have encroached upon a dangerous boundary, which could alert the user to use caution as they approach the equipment 64, or to alert them that they should retreat from the area.

In an embodiment of the present invention, the safety system 10 is tied into the operational units of the equipment 64 and is operative to turn the equipment off upon the transceiver 52 receiving information from the transponder 30. For example, as previously described, the reader 50 is coupled to a power supply 62 of a piece of equipment 64 such that the reader 50 is put into an active state capable of receiving information 34 from the transponder 30 only when the power supply 62 of equipment 64 is flowing. In one embodiment, the reader 50 is operative to cut off the power supply 62 to the equipment 64 after receipt of information from the transponder 30. In an exemplary embodiment, the reader 50 can be tied into the ignition of a powered vehicle such that the reader 50 is operative to both activate once the powered vehicle is started, and send output to shut off the ignition once the reader 50 receives information from the transponder 30 and after sending the second RF link 66 to the base unit 70. Cutting off the power supply 62 to the equipment 64 after sending the RF link 66 would allow the remote alarm 90 to be triggered to alert a caregiver of the potential danger, and would also alleviate the potential danger by shutting down the dangerous equipment 64 as the carrier of the transponder 30 encroaches upon the dangerous boundaries.

The frequency of the system 10 will vary depending on the amount of notification required in terms of transmission range between the reader 50, transponder 30, and base unit 70. In one embodiment, the frequencies of the RF links 56, 66 are between 850 MHz to 950 MHz. In another embodiment, the frequencies are between 2.4 GHz to 2.5 GHz to allow for transmission ranges of over 90 feet. However, it is contemplated that higher frequencies could be used by providing additional power sources into the transponder 30, reader 50, or base unit 70, as required. In one embodiment, the transmission range of the transponder 30 is over 300 feet.

It is contemplated within the scope of the invention that the safety system 10 could comprise a plurality of readers 50 corresponding to a plurality of pieces of equipment 64 which recognize the same transponder 30. The readers 50 and transponder 30 would function in substantially the same way as described above, and would allow a single user carrying the transponder 30 to trigger the remote alarm 90 on any number of operating dangerous pieces of equipment 64 or machinery.

It is also contemplated that the safety system 10 could comprise a plurality of transponders 30 recognizable by an activated reader 50. The transponders 30 and reader 50 would function in substantially the same way as described above, and would allow any one of multiple carriers of the transponders 30 to trigger the remote alarm 90 when encroaching on a dangerous boundary. This could be particularly useful if there is more than one child, pet, or other vulnerable person that could potentially be harmed by the dangerous equipment 64.

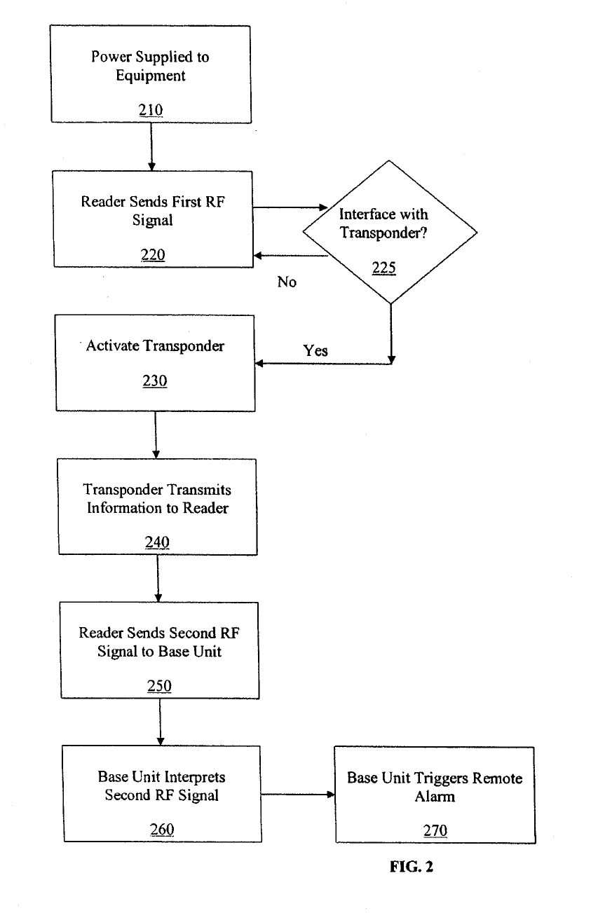

FIG. 2 depicts an example of the usage of the exemplary RFID safety system 10 shown in FIG. 1. Reference numeral 200 generally designates a flow chart depicting the use of the exemplary RFID safety system 10 shown in FIG. 1.

In step 210, a reader is activated by power supplied to a potentially dangerous piece of equipment. In step 220, the activated reader sends out a radio-frequency signal to a pre-programmed radius through a scanning antenna. The radio-frequency signal will interface with a transponder which encroaches on the set boundary of the scanning antenna. If there is no interface with a transponder, the user continues to send out a radio-frequency signal at 225. At step 230, when the transponder passes through the field of the scanning antenna, it detects the signal from the antenna, which “wakes up” the microchip of the transponder. At step 240, the transponder transmits information on its microchip using the transponder's internal power supply to the transceiver of the reader, thus identifying the transponder. At step 250 the transceiver of the reader sends a second radio-frequency signal to a base unit. At step 260 the programmable logic controller of the base unit interprets that second signal, and at step 270, the base unit triggers the remote alarm.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A safety system comprising:
a transponder comprising:
a microchip having embedded therein electronically programmed unique identification information; and
an internal power supply;
a reader coupled to a power supply of a piece of equipment, the reader comprising:
a transceiver; and
a scanning antenna which outputs a first radio-frequency signal to a pre-programmed radius;
a base unit comprising a programmable logic controller; and
a remote alarm,
wherein the reader is put into an active state capable of receiving information from the transponder only when the power supply of equipment is flowing, and further wherein when the transponder encroaches on the pre-programmed radius, the radio-frequency signal of the active reader identifies the transponder's unique identification information, the transponder transmits data through radio waves to the transceiver using the internal power supply, and the transceiver sends a second radio wave signal to the base unit causing the programmable logic controller to trigger the remote alarm.

2. The safety system of claim 1 wherein the equipment comprises farm machinery.

3. The safety system of claim 2 wherein the equipment comprises at least one of an auger; a tractor; and a tiller.

4. The safety system of claim 1 wherein the reader is operable to automatically send output to shut down the power supply of the equipment.

5. The safety system of claim 1 wherein the reader is affixed to a surface of the equipment.

6. The safety system of claim 1 wherein the reader is integrally built into the equipment.

7. The safety system of claim 1 wherein the transponder has attachment means to a user.

8. The safety system of claim 7 wherein the attachment means comprises a child-safety lock.

9. The safety system of claim 7 wherein the transponder is embedded the user's clothing.

10. The safety system of claim 7 wherein the transponder is embedded in a personal accessory.

11. The safety system of claim 10 wherein the attachment means comprises a bracelet.

12. The safety system of claim 1 wherein the transponder is embedded into a portable electronic device.

13. The safety system of claim 1 further comprising a second alarm proximate the equipment.

14. The safety system of claim 1 wherein positional data of the transponder is transmitted along with the triggering of the remote alarm.

15. The safety system of claim 1 wherein the internal power supply comprises a battery.

16. The safety system of claim 15 wherein the battery is replaceable.

17. The safety system of claim 15 wherein the transponder is a sealed unit and wherein the battery is rechargeable.

18. The safety system of claim 1 wherein the frequency of the first radio-wave signal is between 850 MHz to 950 MHz.

19. The safety system of claim 1 wherein the frequency of the first radio-wave signal is between 2.4 GHz to 2.5 GHz.

20. The safety system of claim 1 comprising a plurality of transceivers corresponding to a plurality of pieces of equipment which recognize the same transponder.

21. The safety system of claim 1 comprising a plurality of transponders recognizable by the activated reader.

22. The safety system of claim 1 wherein the remote alarm comprises a cellular phone.
